(19) United States
(12) Patent Application Publication
(10) Pub. No.: US 2009/0003570 A1
(43) Pub. Date: Jan. 1, 2009

(54) Method, system and apparatus for providing endpoint-to-endpoint transcoding free connection

(75) Inventors: Manoj Sindhwani, Oak Hill, VA (US); Piyush Shankerbhai Patel, Germantown, MD (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/819,171

(22) Filed: Jun. 26, 2007

(51) Int. Cl. H04M 1/00; H04L 12/16

(52) U.S. Cl. 379/157; 370/271

(57) ABSTRACT

In a method, system and apparatus for providing an endpoint-to-endpoint transcoding free connection, a customer premises equipment (CPE) at a first or second endpoint encodes and decodes voice data received from and sent to a respective one of first and second media gateways according to an initial codec type. The first and second media gateways perform a Transcoding Free Operation (TFO) negotiation to determine if there is a common codec type among the first and second media gateways and first and second endpoints. If such a common codec type is determined, the first and second media gateways switch from encoding voice data according to the initial codec type to the common codec type and send an indication of the switch to the respective one of the first and second endpoints.

### TECHNICAL FIELD

The technical field relates generally to communication networks and, more particularly, to methods, systems and apparatus for providing a transcoding free connection for a communication link between a first endpoint associated with a first communication network and a second endpoint associated with a second communication network.

### BACKGROUND

Conventionally, many Voice over Internet Protocol (VoIP) service providers provide connections to other VoIP networks or cellular networks via a Time Division Multiplexing (TDM) trunk link to the Public Switched Telephone Network (PSTN). The VoIP service provider can deploy a media gateway to interface with the PSTN. However, a voice communication session between endpoints on a communication link among different communication networks such as different packet-based VoIP networks can involve repeated encoding and decoding of voice speech. For example, a Customer Premises Equipment (CPE) such as a personal computer or VoIP telephone at a first endpoint initiates such a voice communication session by sending a setup message to a first call server of a first communication network requesting a call to be setup with a second endpoint (callee). The setup message includes first endpoint (caller) and second endpoint (callee) specific identification information and supported codec types for encoding and decoding voice data. Exemplary codec types include G.711 or Global System for Mobile Communications Adaptive Multi-Rate (GSM-AMR). Exemplary identification information includes a Session Initiation Protocol (SIP) Uniform Resource Locator (URL), an E.163/E.164 address (telephone number), e-mail user identification, and a peer-to-peer Internet telephony network user identification.

If the second endpoint is associated with a second communication network distinct from the first communication network such as another VoIP network or a cellular network, the first communication network can connect to the second communication network via the PSTN. The first communication network will typically utilize a first media gateway for establishing a voice session with the PSTN. The second communication network will use a second media gateway to connect to the PSTN.

In this case, the first call server will forward the setup message to the first media gateway, which initiates a call setup with the PSTN. The first media gateway and the first endpoint subsequently exchange call setup related messages via the first call server. Some of these messages will include information describing supported codec types for encoding and decoding voice data so that the first endpoint and the first media gateway can determine an initial codec type and a list of available codec types to be used for the first leg of the voice session.

The PSTN will setup a call with a second media gateway associated with the second communication network. The second media gateway sends a set up message to a second call server, which forwards it to the second endpoint. The second media gateway and the second endpoint subsequently exchange call setup related messages via the second call server. Some of these messages will include information describing supported codec types for encoding and decoding voice data so that the second endpoint and the second media gateway can determine an initial codec type and a list of available codec types to be used for the second leg of the voice session.

During the voice session, the first media gateway decodes the voice data encoded by the first endpoint according to the initial codec type of the first leg, encodes the voice data according to a Pulse Code Modulation (PCM) encoding and sends the PCM encoded data to a second media gateway via the PSTN. The second media gateway decodes the PCM encoded voice data, encodes it according to the initial codec type of the second leg and sends the encoded voice data to the second endpoint.

Decoding and encoding the voice data according to different codec types and decoding and encoding the voice data according to PCM encoding at the first and second media gateways can result in degradation of the endpoint-to-endpoint voice quality due to introduction of speech quantization errors inherent in the speech encoding and decoding process. Further, each encoding process may introduce additional delay due to codec algorithm look-ahead delay and possible unequal frame sizes between the initial codec types negotiated in the two legs.

The above problem has previously been addressed within cellular networks by performing a Tandem Free Operation or Transcoding Free Operation (TFO) for setting up a transcoding free connection between first and second Transcoder and Rate Adapter Units (TRAU) connecting two cellular networks. A TRAU and a media gateway provide similar functionality. Here, the first TRAU and the second TRAU perform so-called TFO negotiation with each other to determine if the codec type used for encoding the voice data by its respective endpoint is the same codec. The first TRAU can send and receive the voice data to and from the second TRAU without decoding and encoding the voice data and without encoding it according to PCM encoding if the TFO is successfully negotiated. That is, the voice data can be sent between the first and second TRAUs via the PSTN in a transcode free mode in which the codec type is encoded only by the first and second endpoints if the TFO is successfully negotiated.

A TFO cannot be successfully negotiated if the first leg between the first endpoint and the first TRAU uses a different codec type from the second leg between the second endpoint and the second TRAU. However, although the codec type used by each leg may be different, each entity of the communication link frequently supports more than one codec type, and a common codec type may be available among all of the entities.

Therefore, what is needed is a method, system or apparatus for providing an endpoint-to-endpoint transcoding free connection if a common codec type is available among all of the entities of a communication link.

### SUMMARY

Accordingly, a customer premises equipment (CPE) and a media gateway according to one or more embodiments provides an endpoint-to-endpoint transcoding free connection between a first endpoint and a second endpoint.

The media gateway is connected to the first endpoint via a packet based network and connected to a remote media gateway associated with the second endpoint via a Pulse Code Modulation (PCM) signaling based network such as the Public Switched Telephone Network (PSTN).

The media gateway includes an interface configured to send and receive setup messages indicating codec types supported by the media gateway itself and its respective endpoint, to send Transcoding Free Operation or Tandem Free Operation (TFO) messages to a remote gateway indicating codec types supported by the media gateway and its respective endpoint, to receive TFO messages from the remote media gateway indicating codec types supported by the remote media gateway and its respective endpoint, to send and receive encoded voice data to and from its respective endpoint according to an initial codec type and to send and receive encoded voice data to and from the remote gateway according to PCM encoding.

The media gateway also includes a processor coupled to the interface. The processor is configured to: generate the TFO message and setup message; encode and decode voice data according to the initial codec type; to encode and decode voice data according to PCM encoding; perform a TFO negotiation with the remote media gateway to determine if a common codec type is supported by the first endpoint, the media gateway, the remote media gateway, and the second endpoint based upon an exchange of TFO messages; and switch from encoding voice data to be sent to the first endpoint according to the initial codec type to encoding voice data to be sent to the first endpoint according to the common codec type if a common codec type is determined.

The CPE is connected to a call server of the packet based communication network. The CPE includes an interface configured to: send a setup message including a request for a voice communication link with the remote endpoint and a description of one or more CPE supported codec types for encoding and decoding voice data; receive a setup message from a media gateway or the call server associated with the packet based communication network including a description of one or more gateway supported codec types and an initial codec type to be used for encoding and decoding voice data; and send and receive Real-time Transport Protocol (RTP) packets including encoded voice data to and from the media gateway.

The CPE also includes a processor coupled to the interface. The processor is configured to: generate the setup message; determine the initial codec type to be used based upon a setup message received from a media gateway, and encode and decode voice data to be sent to and received from the media gateway according to the initial codec type; generate RTP packets including the encoded voice data; and switch from the initial codec type to a common codec type to be used for encoding and decoding the voice data after detecting that the media gateway has switched from the initial codec type to a common codec type for providing a transcoding free connection.

The processor of the CPE and the media gateway can be configured by installing a computer-readable medium including executable instructions onto the processor.

A method of providing an endpoint-to-endpoint transcoding free connection between a first endpoint and a second endpoint according to one or more embodiments includes performing a TFO negotiation based upon an exchange of TFO messages between the first media gateway and the second media gateway to determine if a common codec type is supported by the first endpoint, the first media gateway, the second media gateway, and the second endpoint on a call by call basis. The TFO messages can describe the initial codec types, preferred codec types and available codec types.

The method further includes switching from encoding media data at the first media gateway to be sent to the first endpoint from the first initial codec type to the common codec type, thereby sending an in-band indication of the switch to the first endpoint, and switching from encoding media data at the second media gateway to be sent to the second endpoint from the second initial codec type to the common codec type, thereby sending an in-band indication of the switch to the second endpoint; and switching from encoding media data at the first endpoint from the first initial codec type to the common codec type after receiving the in-band indication from the first media gateway and switching from encoding media data at the second endpoint from the second initial codec type to the common codec type after receiving the in-band indication from the second media gateway.

The method further includes sending encoded media data between the first and second media gateways in a transcode free mode in which the encoded media data is transported in a TFO frame over PSTN links.

The media gateways can exchange the TFO messages within TFO frames according to a TFO protocol.

### BRIEF DESCRIPTION OF THE DRAWINGS

The accompanying figures, in which like reference numerals refer to identical or functionally similar elements, together with the detailed description below are incorporated in and form part of the specification and serve to further illustrate various exemplary embodiments and explain various principles and advantages in accordance with the present invention.

FIG. 1 is a diagram illustrating a simplified and representative environment in which a method, system or apparatus for providing an endpoint-to-endpoint transcoding free connection can be implemented;

FIG. 2 is a block diagram of an exemplary Customer Premises Equipment (CPE);

FIG. 3 is a block diagram of an exemplary media gateway;

FIGS. 4A-4B are flow diagrams illustrating an exemplary procedure for establishing a communication link between a first endpoint and a second endpoint and providing an endpoint-to-endpoint transcoding free connection on the communication link;

FIG. 5 is an illustration of an exemplary Session Initiation Protocol (SIP) message including an exemplary Session Description Protocol (SDP) portion; and

FIGS. 6A-6C are message flow diagrams illustrating exemplary operations of network entities.

### DETAILED DESCRIPTION

In overview, the present disclosure concerns communication networks, and entities in the communication networks, such as call servers, media gateways and communication devices at originating and terminating endpoints. More particularly, various inventive concepts and principles are embodied in systems, apparatus, and methods therein for providing a transcoding free connection for a voice communication session between endpoints.

The instant disclosure is provided to further explain in an enabling fashion the best modes of performing one or more embodiments of the present invention. The use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in computer instructions (software) or integrated circuits (ICs), and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

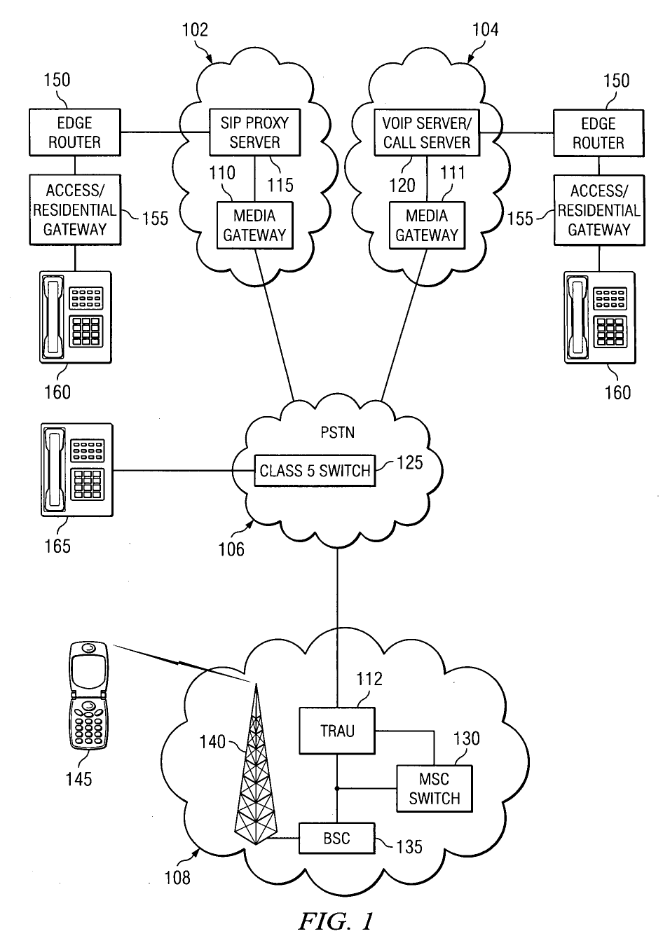

Referring to FIG. 1, an exemplary network environment including exemplary communication networks in which the systems, apparatus, and methods of the present invention can be implemented will be discussed.

The communication networks include a first Voice over Internet Protocol (VoIP) network 102, a second VoIP network 104, a Public Switched Telephone Network (PSTN) 106, and a mobile switching network (or cellular network) 108. The first and second VoIP networks 102, 104 and the mobile switching network 108 can be connected to the PSTN 106 by media gateways 110, 111 and a Transcoder and Rate Adapter Unit (TRAU) 112 for providing signaling translation, signaling transport conversion and transcoding between audio signals carried on telephone circuits and encoded voice packets carried over the VoIP networks 102, 104 and the mobile switching network 108. A TRAU and a media gateway will both be referred to here as a media gateway, as both provide similar functionality. That is, in this disclosure, the term “media gateway” refers to a TRAU, a media gateway and the like.

Each of the communication networks includes a so-called call manager or call server for providing call logic and call control functions. The configuration of the call manager will depend upon the particular communication network. For example, the first VoIP network 102 can include a Session Initiation Protocol (SIP) proxy server 115 as the call manager, the second VoIP network 104 can include a VoIP server 120 as the call manager, the PSTN 106 can include a class 5 switch 125 as the call manager, and the mobile switching network 108 can include a mobile switching center (MSC) switch 130 as the call manager.

The mobile switching network 108 includes a base station controller (BSC) 135 for controlling one or more base stations 140 to thereby provide communication services to a client (hereinafter referred to interchangeably as client or endpoint) via an exemplary cellular telephone 145 having a wireless connection with one of the base stations 140. A cellular telephone 145 will be referred to here also as customer premises equipment (CPE) for the sake of brevity, although a cellular telephone is not limited to premises. Media data at the CPE 145 such as voice or video data can be encoded according to a codec type by the CPE 145 into audio packets using a cellular transport protocol.

Each of the first and second VoIP networks 102, 104 can include edge routers 150 for routing IP traffic onto the carrier backbone network and an access/residential gateway 155 for providing support for plain old telephone service (POTS) phones. The access/residential gateway 155 is typically controlled by the call server of the VoIP network through a device control protocol such as H.248 (Megaco), media gateway control protocol (MGCP) or call control protocol such as SIP/H.323 if the access/residential gateway 155 is providing a traditional analog (RJ11) interface to a POTS telephone. The residential gateway 155 can be, for example, a voice enabled cable modem/cable set-top box, an xDSL device, terminal adapter, or a broad-band wireless device.

The CPE 160 can receive communication service from a respective one of the first and second VoIP networks 102, 104 through the access/residential gateway 155 or directly from the edge routers 150. The CPE 160 can be a POTS telephone, IP telephone, personal computer, or the like. Media data at the CPE 160 such as voice or video data can be encoded according to a codec type by the CPE 160 or the access/residential gateway 155 into packets using Real-time Transfer Protocol (RTP) and User Datagram Protocol (UDP). The media data can alternatively be encoded by the access/residential gateway 155.

A client of the PSTN 106 can receive communication services by connecting a CPE 165 to a subscriber line coupled to the class 5 switch 125 at the PSTN 106.

The communication networks are not limited to the network types above. For example, the communication networks can also include a Voice over ATM network including a Voice over ATM media gateway operating similarly to the above media gateways in which voice data can be transmitted as audio packets using an ATM Adaptation Layer protocol over the ATM network. The PSTN 106 can merely be a Pulse Code Modulation (PCM) signaling based network.

A client of one of the networks above attempting to establish a communication link with a destination entity will be referred to alternatively as a first endpoint, local endpoint or originating endpoint. The destination entity will be referred to alternatively as a second endpoint, local endpoint, terminating endpoint or remote endpoint. The endpoints can be, for example, one of the CPEs 145, 160, 165, one of the media gateways 110, 111, 112 or one of the call managers such as the MSC switch 130, SIP proxy server 115, or VoIP server 120. The first endpoint and the second endpoint may be connected by a plurality of distinct networks not shown.

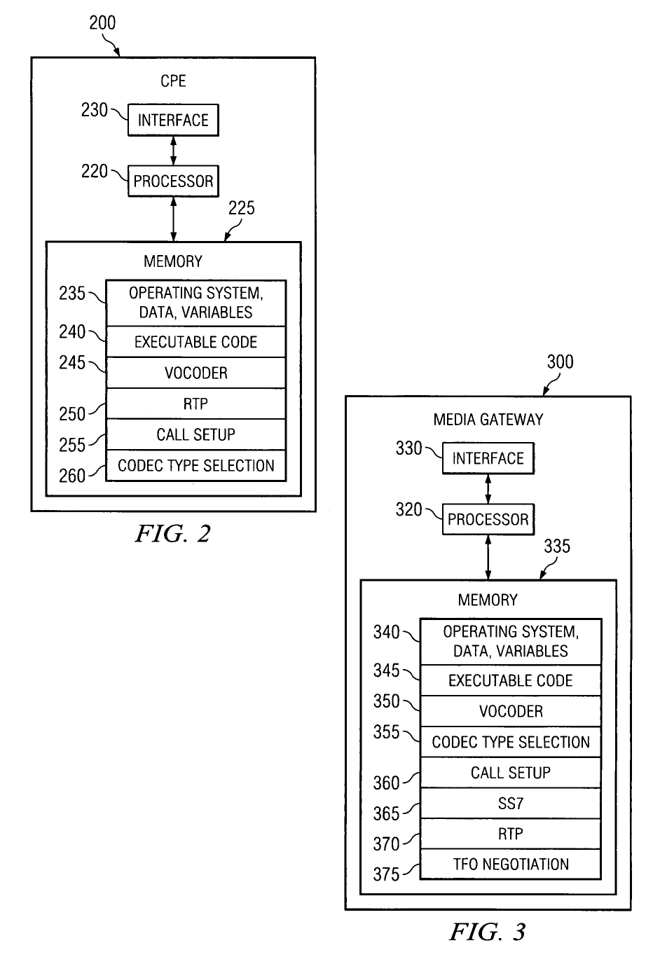

Referring to FIG. 2, an exemplary CPE 200 that can be implemented at an endpoint of any of the above VoIP networks will be discussed in further detail. The CPE 200 can include a processor 220, a memory 225 coupled to the processor 220, and an interface 230 for coupling the processor 220 to internal entities such as a microphone or speaker and external entities such as the media gateway or call server of an associated VoIP network.

The interface 230 is for sending and receiving setup messages to an associated media gateway or call server, and for sending and receiving RTP packets including encoded voice data to and from another endpoint via the call server or media gateway.

The processor 220 can be one of a variety of different processors including general purpose processors, custom processors, controllers, compact eight-bit processors or the like. The memory 225 can be one or a combination of a variety of types of memory such as random access memory (RAM), read only memory (ROM), flash memory, dynamic RAM (DRAM) or the like.

The memory 225 can include a basic operating system, data, and variables 235 and executable code 240. The memory 225 can further include computer programs (or executable instructions) for configuring the processor 220 to perform the tasks required of the CPE 200. Particularly, the memory 225 can include: vocoder instructions 245; RTP instructions 250; call set up instructions 255; and codec type selection instructions 260, each of which will be discussed in more detail below.

The vocoder instructions 245 are for configuring the processor 220 to encode and decode media data or alternatively compress and decompress media data such as voice speech or video according to a codec type such as, for example, G.711, G.723, G.729AB or Global System for Mobile Communications Adaptive Multi-Rate (GSM-AMR). The RTP instructions 250 are for configuring the processor 220 to generate the RTP packets including the encoded media data to be sent by the interface 230 and to process RTP packets received by the interface 230 from another network entity such as the caller server or media gateway. The call set up instructions 255 are for configuring the processor 220 to generate setup messages including a request for a communication link with a remote endpoint and one or more CPE supported codec types for encoding and decoding voice data to be sent or received by the interface 230. The codec type selection instructions 260 are for configuring the processor 220 to determine an initial codec type to be used for encoding and decoding or compressing and decompressing the media data.

The call set up instructions 255 can further configure the processor 220 to process setup messages received by the interface 230 from the media gateway or call server. The codec type selection instructions 260 can further configure the processor 220 to determine the initial codec type based upon the setup message received from the media gateway or the call server. The received and sent setup messages can be, for example, Session Initiation Protocol (SIP) messages or H.323 protocol messages including a Session Description Protocol (SDP) message or portion having “m=” media fields describing media types and one or more “a=” media attribute fields for describing the one or more supported codec types. The setup messages can also be Megaco messages.

The RTP instructions 250 can further configure the processor 220 to generate the RTP packets to include a header having a payload type field with a value specifying the codec type of the encoded voice data. The RPT instructions 250 can further be for configuring the processor 220 to change the value the payload type field of the header of the RTP packets when the CPE switches to a different codec type in accordance with the codec selection instructions 260 and to also detect a change in the payload type of received RTP packets. The gateway or the call server can detect the switch to a different codec type by the change in the payload type.

The codec type selection instructions 260 can further configure the processor 220 to switch from the initial codec type to a common codec type in accordance with the detected change in the payload type field in the header of the RTP packets received from the media gateway or call server (detected by the RTP instructions 250). The new value of the payload type field indicates that the media gateway has switched from the initial codec to a common codec for providing a transcoding free connection.

Referring to FIG. 3, an exemplary media gateway 300 for providing a transcoding free connection between a first endpoint and a second endpoint will be discussed. The media gateway 300 can be connected to, for example, a CPE at one of the first or second endpoints via a packet based network such as a VoIP network and connected to a remote media gateway associated with the other of the first or second endpoints via a Pulse Code Modulation (PCM) signaling based network such as the PSTN. The media gateway 300 includes a processor 320, a memory 335 coupled to the processor 320, and an interface 330 for coupling the processor 320 to internal entities and external entities such as, for example, the PCM signaling based network, or call server of the VoIP network such as a SIP proxy server.

The interface 330 is generally for sending and receiving call setup messages and Transcoding Free Operation or Tandem Free Operation (TFO) messages, sending and receiving RTP packets including encoded voice data to and from the first or second endpoints or a call server, and sending and receiving PCM encoded voice data or encoded voice data to and from a remote media gateway via the PCM signaling based network. It should be noted that the interface 330 could be implemented to include a first interface connected towards the local network and a second interface connected toward a TDM trunk of the PSTN rather than as a single interface as shown.

The processor 320 can be one of a variety of different processors including general purpose processors, custom processors, controllers, compact eight-bit processors or the like. The memory 335 can be one or a combination of a variety of types of memory such as RAM, ROM, flash memory, DRAM or the like.

The memory 335 can include a basic operating system, data, and variables 340 and executable code 345. The memory 335 can further include computer programs (or executable instructions) for configuring the processor 320 to perform the tasks required of the media gateway 300. Particularly, the memory 335 can include: vocoder instructions 350; codec type selection instructions 355; call setup instructions 360, Signaling System#7 (SS7) message instructions 365, RTP instructions 370, and TFO negotiation instructions 375, which will each be discussed in more detail below.

The vocoder instructions 350 are for configuring the processor 320 to encode and decode or compress and decompress media data according to an initial codec type. The codec type selection instructions 355 are for determining the initial codec type based upon a setup message exchange with the CPE at the endpoint local to the media gateway 300.

The call set up instructions 360 are for configuring the processor 320 to generate setup messages (media gateway setup messages) including one or more gateway supported codec types for encoding and decoding media data to be sent by the interface 330, and to process received setup messages indicating codec types supported by the endpoint local to the gateway (the setup message exchange). The received and sent setup messages can be SIP messages or H.323 protocol messages including a SDP message or portion having “m=” media fields describing media types and one or more “a=” media attribute fields for describing the one or more supported codec types. The setup messages can also be Media Gateway Control Protocol (MGCP) messages or Megaco messages. The interface 330 can send the setup messages to the local endpoint.

The SS7 instructions 365 are for configuring the processor 320 to generate and process SS7 messages for delivering a telephone call across the PSTN.

The RTP instructions 370 are for configuring the processor 320 to generate and process RTP packets including encoded voice data.

The TFO negotiation instructions 375 are for configuring the processor 320 to perform TFO negotiations with a remote media gateway to determine if a common codec type is supported by the first endpoint, the media gateway 300, the remote media gateway, and the second endpoint based upon an exchange of TFO messages with the remote media gateway. Particularly, the TFO negotiation instructions 375 can configure the media gateway 300 to generate a TFO message including a description of the codec types supported by the media gateway 300 and the local endpoint to be sent to the remote media gateway. For example, the media gateway can generate TFO frames inserted into the PCM sample bit stream to be sent by the interface 330 to the remote media gateway over the PSTN. The TFO messages can be embedded within the TFO frames and exchanged between the media gateway and the remote gateway according to a TFO protocol as described in “3GPP2 Tandem Free Operation Specification Release A” dated Jan. 18, 2000 and authored by the 3^{rd} Generation Partnership Project 2 (3GPP2), the contents of which are incorporated herein by reference. Although the TFO protocol disclosed in this document is for cellular codecs such as GSM, the TFO protocol can be extended to support most VoIP codecs such as G.729.

The codec type selection instructions 355 are further for configuring the processor 320 to switch from encoding voice data to be sent to the first endpoint according to the initial codec type to encoding voice data to be sent to the first endpoint according to the common codec type if a common codec type is determined by the TFO negotiation. The RTP instructions 370 can further be for configuring the processor 320 to change the value of the payload type field of the header of the RTP packets when the gateway 300 switches to a different codec type in accordance with the codec selection instructions 355 and to also detect a change in the payload type of received RTP packets. The codec type selection instructions 355 can configure the processor 320 to subsequently switch the decoding to the different codec type after detecting the change. The CPE or the call server can detect the switch to a different codec type by the change in the payload type.

The received setup messages can include a first endpoint message including a description of the one or more codec types supported by the first endpoint. The first endpoint message can be received by the interface 330 from a first call server associated with the first endpoint.

It should be noted that the CPE 200 and the media gateway 300 can include alternative mechanisms for indicating the switch to a different codec type, such as, for example, reusing different existing RTP fields or generating a special RTP packet indicative of the switch.

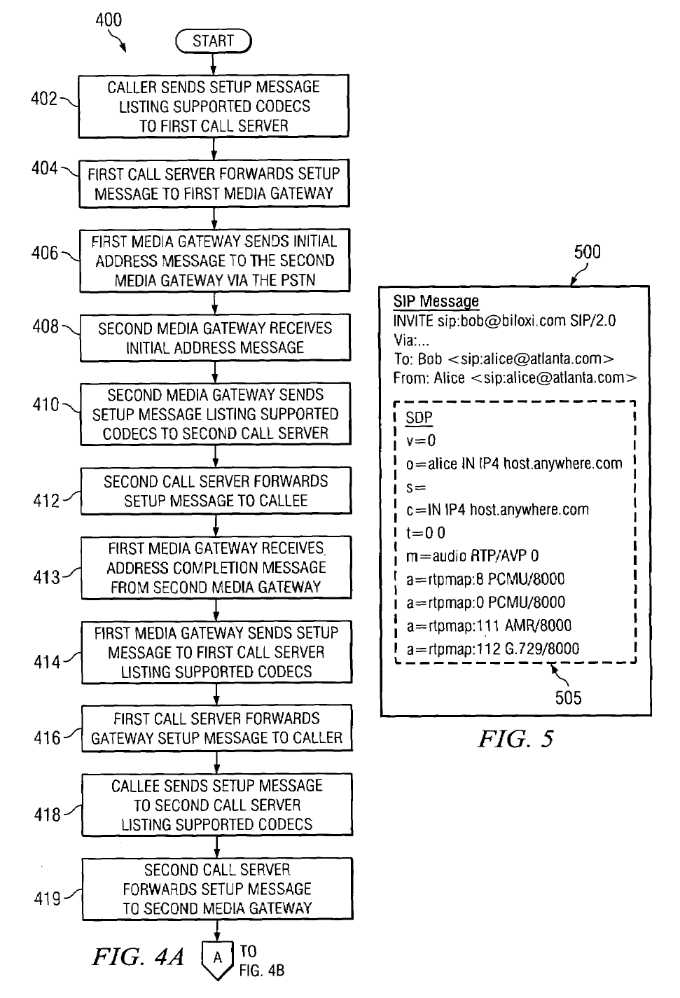

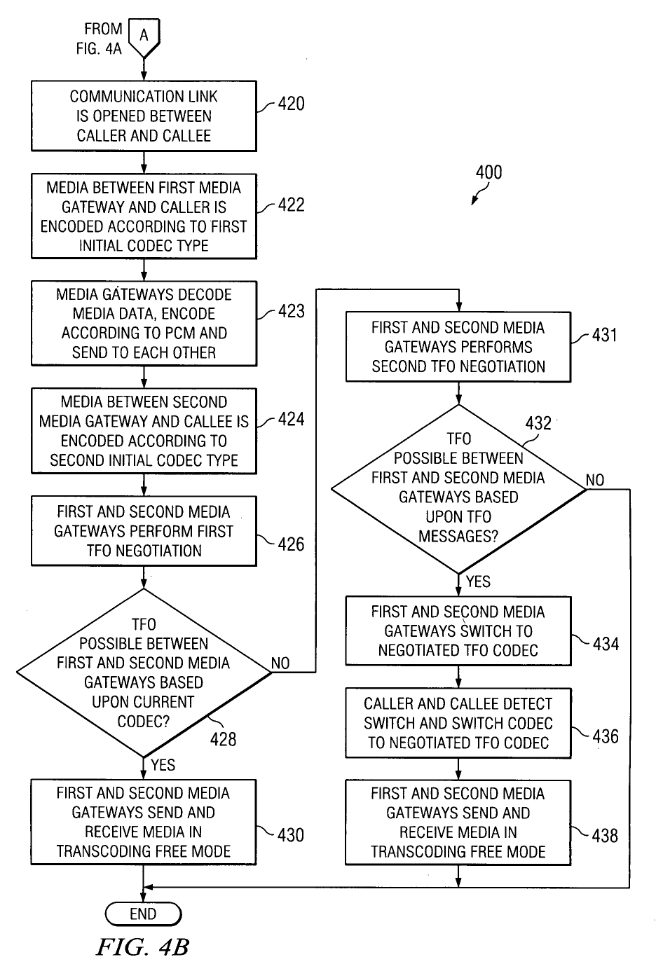

Referring to FIGS. 4A-4B, an exemplary procedure 400 for establishing a transcoding free connection on a communication link between a caller at the first endpoint and a callee at the second endpoint will be discussed. The first and second endpoints are respectively at first and second communication networks such as a packet based communication network or a cellular communication network. However, it should be understood that the communication link may possibly include one or more communication networks between the first and second communication networks.

At 402, the caller at the first endpoint initiates a call to the callee at the second endpoint by sending a setup message to a call server at the caller's service provider (hereafter referred to as “first call server”). The setup message can be, for example, a SIP message or an H.323 protocol message such as an INVITE request or an admission request (ARQ) message. The setup message includes caller and callee (client) specific identification information such as a SIP URL, an E.163/E.164 address (telephone number), e-mail user identification, a peer-to-peer Internet telephony network user identification or the like, a request for a communication link with the callee at the second endpoint, and a list of one or more codec types supported by the caller. If the call request is a SIP message, it can include a Session Description Protocol (SDP) message or portion including an “m=” media field describing a media type and one or more “a=” media attribute fields for describing the one or more supported codec types.

At 404, the first call server forwards the setup message to a media gateway for the caller's network (hereafter referred to as “first media gateway”). The first media gateway couples the caller's network to a PCM signaling based network such as the PSTN.

At 406, the first media gateway sends an SS7 message such as an initial address message (IAM) to a media gateway for the callee's network (hereafter referred to as “second media gateway”) via the PSTN, including the identification information for the caller and the callee.

At 408, the second media gateway receives the IAM message from the first media gateway. At 410, the second media gateway sends a setup message listing second gateway supported codec types to a call server at the callee's service provider (hereafter referred to as “second call server”). At 412, the second call server forwards the gateway setup message to the callee.

At 413, the first media gateway receives an address complete message (ACM) from the second media gateway. The second media gateway sends the ACM message when the callee's phone is ringing. At 414, the first media gateway sends a gateway setup message in reply to the caller's setup message to the first call server including a list of one or more codec types supported by the first media gateway and a first initial codec type to be used by the caller and the first media gateway for encoding and decoding media data. At 416, the first call server forwards the gateway setup message to the caller. The caller uses the first initial codec type specified in the gateway setup message for encoding and decoding media data. It should be appreciated by those skilled in the art that numerous other SS7 messages may be exchanged between the entities in addition to the IAM and ACM messages described above.

At 418, the callee sends a setup message in reply to the setup message from the second media gateway listing callee supported codec types to the second call server. At 419, the second call server forwards the callee setup message to the second media gateway.

At 420, a communication link is opened between the caller and the callee. The communication link includes a first leg between the caller and the first media gateway and a second leg between the second media gateway and the caller. The first leg and the second leg are connected to each other via the PCM based PSTN links.

At 422, the caller and the first media gateway send and receive RTP packets including media data encoded according to the first initial codec type to each other over the first communication network.

At 423, the first media gateway and the second media gateway decode or decompress the encoded media data received from the caller and the callee, encode the media data according to PCM encoding and send the PCM encoded media data to each other via the PCM based PSTN links. The first media gateway and the second media gateway also decode received PCM encoded media data and encode or compress the media data according to the first and second initial codec types, respectively, to be sent to a respective one of the caller and callee.

At 424, the callee and the second media gateway send and receive RTP packets to each other over the second communication network including media data encoded according to the second initial codec type.

At 426, the first and second media gateways perform a first TFO negotiation in which TFO messages containing information regarding the first initial codec type associated with the first media gateway and the second initial codec type associated with the second media gateway are exchanged. The TFO messages can be, for example, TFO_REQ messages describing the initial codecs.

At 428, the first and second media gateways determine if a TFO is possible based upon the exchange of TFO messages. Particularly, the first media gateway receives a TFO message from the second media gateway describing the locally used codec type of the second media gateway (the second initial codec) and the second media gateway receives a TFO message from the first media gateway describing the locally used codec type of the first media gateway (the first initial codec). That is, the first and second media gateways determine if the first and second initial codecs (currently used codecs) are similar.

If a TFO is determined to be possible based upon the first TFO negotiation (YES at 428), then at 430 the first and second media gateways can exchange TFO_ACK messages followed by TFO_TRANS messages, and switch from decoding the media data received from the caller and callee and encoding the media data according to the PCM encoding, to sending the encoded media data via the PCM links to the PSTN according to the first and second initial codec types, which are the same (the negotiated TFO codec type). That is, the encoded media data is sent from the first endpoint to the second endpoint in a transcoding free mode using TFO framing, and the process ends.

If a TFO is determined to not be possible based upon the first TFO negotiation (NO at 428), then at 431 the first and second media gateways perform a second TFO negotiation based upon an exchange of TFO messages describing all of the codec types supported by the first media gateway and the caller, and the second media gateway and the callee. In particular, at 431, the first and second media gateways exchange TFO_REQ_L messages after determining NO at 428. Then the first and second media gateways exchange TFO_ACK_L messages describing all of the codec types supported by the media gateway and its respective endpoint (caller or callee). The TFO_ACK_L or TFO_REQ_L messages can be generated based upon the SDP portions of the setup messages received from the caller or callee at 404 and 419. If a TFO is determined to not be possible based upon the second TFO negotiation (NO at 432), then the procedure ends.

If a TFO is determined to be possible based upon the second TFO negotiation (YES at 432), then at 434, the first media gateway and the second media gateway switch from decoding and encoding the media data received from and sent to the caller and callee according to the first and second initial codec types to decoding and encoding the media data according to the common codec type (negotiated TFO codec). Switching to the common codec type will cause a change in the payload type of the RTP packets. Alternatively, here the first and second media gateway can send a special in-band RTP packets to their respective endpoints informing of the switch to the common codec type.

At 436, the caller and callee detect the switch by the first and second media gateways based upon the change in the payload type of the RTP packets, and switch to encoding and decoding the media data according to the common codec type (negotiated TFO codec).

At 438, the first and second media gateways switch from decoding the media data received from the caller and callee and encoding the media data according to the PCM encoding to sending the encoded media data via the PCM signaling based network encoded according to the negotiated TFO codec type. It should be noted that the first and second media gateways can switch the decoding simultaneously with the switch at 434. Thus, the media data is sent from the first endpoint to the second endpoint in a transcoding free mode, and the procedure ends.

As discussed above, the setup messages can be SIP messages including an SDP portion. An exemplary SIP message 500 is shown in FIG. 5. The SIP message 500 is an INVITE message including identification information for the callee “sip:bob@biloxi.com” and identification information for the caller “sip:alice@atlanta.com.” The SIP message 500 includes an SDP portion 505 having an “m=” media field describing a media type “audio RTP/AVP” and a plurality of “a=” media attribute fields for describing a plurality of supported codec types “PCMU, AMR and G.729.”

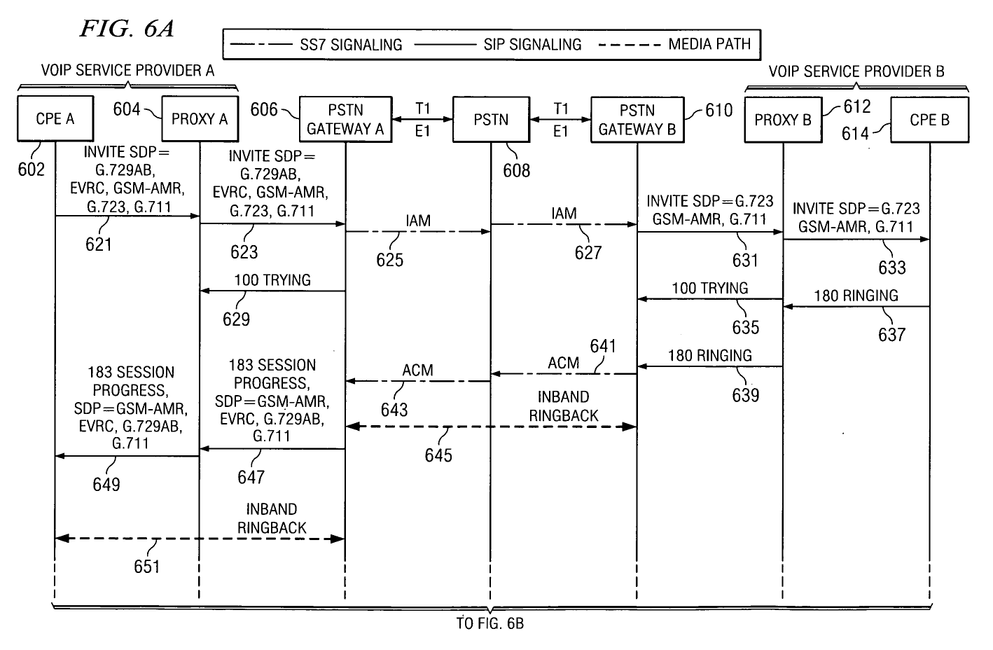

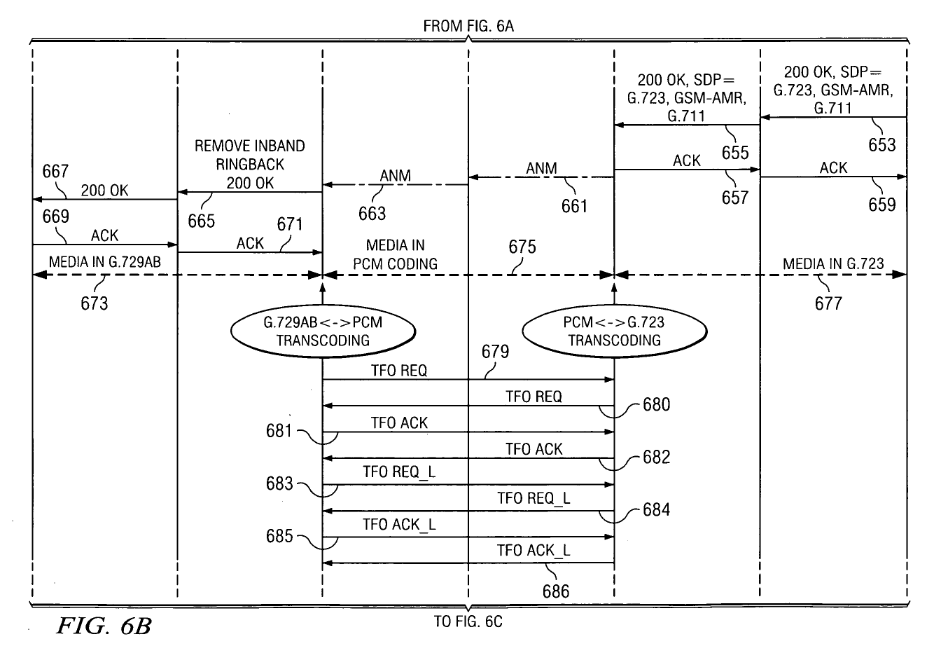

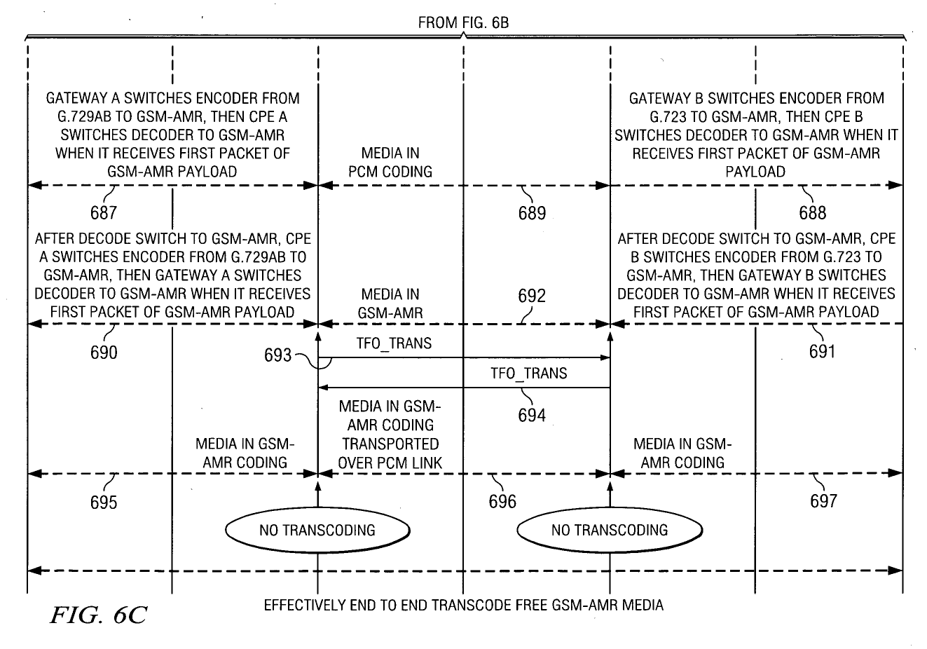

Referring to FIGS. 6A-6C, exemplary operations of network entities will be discussed in an exemplary case in which a communication link is established between a first endpoint of a first VoIP network (VoIP Service Provider A) and a second endpoint of a second VoIP network (VoIP Service Provider B). The network entities include CPE A 602 at the first endpoint, a first proxy server (Proxy A) 604, a first media gateway (PSTN Gateway A) 606, the PSTN 608, a second media gateway (PSTN Gateway B) 610, a second proxy server (Proxy B) 612 and a CPE B 614 at the second endpoint.

At 621, CPE A sends an INVITE message including an SDP portion specifying G.711, G.729AB, EVRC, GSM-AMR and G.723 as supported codec types to Proxy A by SIP signaling as well as identification information for CPE B. The INVITE message can be generated when CPE A dials, for example, an E.164 number for CPE B.

At 623, Proxy A forwards the INVITE message to Gateway A by SIP signaling. At 625, Gateway A sends an IAM message including the identification information for the originating point (CPE A) and the destination point (CPE B) to the PSTN by SS7 signaling to reserve an idle trunk circuit from Gateway A to Gateway B. At 627, the PSTN routes the IAM message to Gateway B. At 629, Gateway A sends a 100 TRYING message to Proxy A in reply to the INVITE message.

At 631, Gateway B sends an INVITE message having an SDP portion specifying G.723, GSM-AMR and G.711 as supported codec types to Proxy B, which forwards it to CPE B at 633. At 635, Proxy B sends a 100 TRYING message to Gateway B.

At 637, CPE B sends a 180 RINGING message to Proxy B, which forwards it to Gateway B at 639. At 641, Gateway B sends an address complete message (ACM) to the PSTN to indicate that the switched circuit has been setup to the callee. At 643, the PSTN routes the ACM message to Gateway A. At 645, the terminating switch provides inband ringback.

At 647, Gateway A sends a 183 SESSION PROGRESS message by SIP signaling to Proxy A. The 183 message includes an SDP portion specifying G.729AB, GSM-AMR, EVRC and G.711 as supported codec types. At 649, Proxy A forwards the 183 SESSION PROGRESS message to CPE A. Both Gateway A and CPE A select G.729AB as the first initial codec type based upon the SDP portion included in the 183 message. At 651, audible ringing tone (inband ringback) is provided to the calling party (CPE A).

At 653, CPE B sends a 200 OK message to Proxy B by SIP signaling indicating that callee has answered the call. The 200 OK message includes an SDP portion specifying G.723, GSM-AMR and G.711 as supported codec types. Both CPE B and Gateway B will select G.723 as initial codec based on this list of supported codec types in SDP.

At 655, Proxy B forwards the 200 OK message to Gateway B. At 657, Gateway B sends an ACK message to Proxy B, which forwards it to CPE B at 659.

At 661, Gateway B sends an answer message (ANM) to the PSTN to indicate that CPE B has picked up the phone. At 663, the PSTN terminating switch removes the in-band ringback tone and routes the ANM to Gateway A.

At 665, Gateway A sends a 200 OK message to Proxy A. At 667, Proxy A forwards the 200 OK message received from Gateway A to CPE A. At 669, CPE A sends an ACK message to Proxy A, which forwards the ACK message to Gateway A at 671.

A communication link is opened between CPE A and CPE B in which media is encoded according to G.729AB encoding (the first initial codec type) in the leg between CPE A and Gateway A at 673 (hereafter referred to as “A leg”). At 675, the media is encoded according to PCM encoding between Gateway A and Gateway B. The media is encoded according to G.723 encoding (the second initial codec type) in the leg between CPE B and Gateway B at 677 (hereafter referred to as “B leg”). That is, Gateway A transcodes the media between G.729AB encoding and PCM encoding, and Gateway B transcodes the media between G.723 encoding and PCM encoding.

At 679-682, Gateway A and Gateway B perform first TFO negotiations to determine if the first initial codec type of the A leg is similar to the initial codec type of the B leg. At 679 and 680, Gateway A and Gateway B exchange TFO_REQ messages, and at 681 and 682, Gateway A and Gateway B exchange TFO_ACK messages. The TFO_REQ message can include the local used codec type at the sender side, as well as a local signature and system identification. The TFO_ACK message can include a local used codec type at the sender side, as well as a reflected signature copied from the received TFO_REQ message and system identification. The first TFO negotiations are not successful because the A and B legs are using different codec types (G.729AB and G.723).

At 683-686, Gateway A and Gateway B perform second TFO negotiations to determine if a common codec type is supported by CPE A at the first endpoint, Gateway A, Gateway B, and CPE B. At 683 and 684, Gateway A and Gateway B exchange TFO_REQ_L messages, and at 685 and 686, Gateway A and Gateway B exchange TFO_ACK_L messages. The TFO_REQ_L message generated by each of the gateways can include the initial codec type, and a list of alternative codec types supported by the gateway itself and its respective CPE (local codec list), which are determined based upon the SDP portions of the INVITE messages received from its proxy. The TFO_ACK_L messages generated by the gateways can include the initial codec type, and a list of alternative codec types supported by the gateway itself and its respective CPE (local codec list), which are determined based upon the SDP portions of the Invite messages received from its proxy, and a reflected signature copied from the TFO_REQ_L message and a system identification. Both Gateway A and Gateway B will select GSM-AMR as the common codec based on the alternative codec list in TFO_RE_L message

At 687, Gateway A switches the encoder from G.729AB encoding of media to GSM-AMR encoding on the call leg between Gateway A and CPE A. This switch is indicated, among other things, by changing the payload type field in the RTP header of the media RTP packets from the one corresponding to G.729AB to the one corresponding to GSM-AMR. When CPE A receives the first RTP packet with the new payload type (corresponding to GSM-AMR), it detects that the encoding of the entity with which it is communicating, in this case Gateway A, has switched the encoder. CPE A then switches its decoding from G.729AB to GSM-AMR in order to decode correctly. The Gateway A may also send additional in-band indication such as, for example, a special RTP packet, or using any unused or proprietary fields of RTP header of the media data packets to CPE A, to indicate to CPE A to switch its encoding to the same as its decoding upon switching the decoding, or to explicitly indicate which encoding to switch to, such as GSM-AMR in the present case. The Gateway A does not switch its decoder at this time to GSM-AMR because CPE A is still sending encoded G.729AB packets. If Gateway A switches decoding before CPE A switches encoding to GSM-AMR, it will result in wrong decoding and therefore create voice quality degradation.

At 688 Gateway B switches the encoder from G.723 encoding of media to GSM-AMR encoding on the call leg between Gateway B and CPE B. This switch is achieved, among other things, by changing the payload type field in the RTP header of the media RTP packets from the one corresponding to G.723 to the one corresponding to GSM-AMR. When CPE B receives the first RTP packet with the new payload type (corresponding to GSM-AMR), it detects that the encoding of the entity with which it is communicating, in this case Gateway B, has switched the encoder and in order to decode correctly, the CPE B switches its decoding from G.723 to GSM-AMR. The Gateway B may send additional in-band indication, which could for example, be a special RTP packet, or using any unused or proprietary fields of RTP header of the media data packets to CPE B, to indicate CPE B to switch its encoding to the same as its decoding whenever decoding switch happens at CPE B or explicitly indicate which encoding to switch to, in this case GSM-AMR. The Gateway B does not switch its decoder at this time to GSM-AMR because CPE B is still sending encoded G.723 packets, and so, if Gateway B switches decoding before CPE B switches encoding to GSM-AMR, it will result in wrong decoding and therefore create voice quality degradation.

At 689, Gateway A and Gateway B transcode the media between GSM-AMR encoding and PCM encoding.

At 690, CPE A, after detecting the payload type change and changing its decoding from G.729AB to GSM-AMR, determines to switch its encoding to the same codec (i.e GSM-AMR), either autonomously based on the decoding switch or after receiving a separate in-band indication from Gateway A as mentioned earlier. The CPE A switches its encoding from G.729AB to GSM-AMR. This switch is indicated, among other things, by changing the payload type field in the RTP header of the media RTP packets from the one corresponding to G.729AB to the one corresponding to GSM-AMR. When Gateway A receives the first RTP packet with the new payload type (corresponding to GSM-AMR), it detects that the encoding of the entity with which it is communicating, in this case CPE A, has switched the encoder and in order to decode correctly, the Gateway A switches its decoding from G.729AB to GSM-AMR.

At 691 CPE B, after detecting the payload type change and changing its decoding from G.723 to GSM-AMR, determines to switch its encoding to the same codec (i.e GSM-AMR), either autonomously based on the decoding switch or after receiving a separate in-band indication from Gateway B as mentioned earlier. The CPE B switches its encoding from G.723 to GSM-AMR. This switch is indicated, among other things, by changing the payload type field in the RTP header of the media RTP packets from the one corresponding to G.723 to the one corresponding to GSM-AMR. When Gateway B receives the first RTP packet with the new payload type (corresponding to GSM-AMR), it detects that the encoding of the entity with which it is communicating, in this case CPE B, has switched the encoder and in order to decode correctly, the Gateway B switches its decoding from G.723 to GSM-AMR.

At 692 Gateway A and Gateway B send and receive the media as GSM-AMR encoded media data. At 693 and 694, Gateway A and Gateway B exchange TFO_TRANS messages to permit TFO frames to pass transparently. The TFO_TRANS messages can include a local channel type.

At 695 CPE encodes media according to GSM-AMR and sends it to Gateway A. At 696, Gateway A sends the GSM-AMR encoded media data over the PCM link to the PSTN to Gateway B using TFO framing. At 697, CPE B decodes the media data according to GSM-AMR. That is, the media is sent in a transcoding free mode.

Although the above description of exemplary operations involved first and second CPEs at VoIP networks, the above embodiment can also be implemented in a network environment in which one of the first or second CPEs is associated with a cellular network. In such a case, the CPE of the cellular network will be connected to the PSTN via a TRAU as shown in FIG. 1. However, the TRAU does not use the RTP headers and hence can not use payload type to indicate switchover. Accordingly, the TRAU can communicate with the BSCs to change the encoder used on the cellular side.

It should be noted that although the above embodiments describe the initial setup message being generated by a CPE at the first endpoint, the setup message can alternatively be generated at different network entities such as the first or second media gateways.

This disclosure is intended to explain how to fashion and use various embodiments in accordance with the invention rather than to limit the true, intended, and fair scope and spirit thereof The invention is defined solely by the appended claims, as they may be amended during the pendency of this application for patent, and all equivalents thereof. The foregoing description is not intended to be exhaustive or to limit the invention to the precise form disclosed.

Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A media gateway for providing a tandem free connection between a local endpoint and a remote endpoint, the media gateway connected to the local endpoint via a Voice over Internet Protocol (VoIP) network and connected to a remote media gateway associated with the remote endpoint via a Pulse Code Modulation (PCM) based Time Division Multiplexing (TDM) trunk, the media gateway comprising:
an interface configured to receive a setup message indicating codec types supported by the local endpoint, to send and receive encoded voice data to and from the local endpoint according to an initial codec type, to send and receive encoded voice data to and from the remote gateway according to a PCM encoding, to send a local Tandem Free Operation (TFO) message describing codec types supported by the local endpoint and the media gateway to the remote media gateway, and to receive a remote TFO message describing codec types supported by the remote endpoint and the remote media gateway from the remote media gateway; and
a processor coupled to the interface, the processor configured to:
encode and decode voice data according to the initial codec type and to encode and decode voice data according to the PCM encoding;
generate the local TFO message describing the codec types supported by the local endpoint and the media gateway;
perform a TFO negotiation with the remote media gateway to determine if a common codec type is supported by the local endpoint, the media gateway, the remote media gateway, and the remote endpoint based upon the local and remote TFO messages; and
switch from encoding voice data to be sent to the local endpoint according to the initial codec type to encoding voice data to be sent to the local endpoint according to the common codec type if the common codec type is determined to be supported by the TFO negotiation.

2. The media gateway according to claim 1, wherein the processor is further configured to generate an in-band message with a payload type specifying the common codec type when switching from encoding the voice data to be sent to the local endpoint according to the initial codec type to encoding the voice data to be sent to the local endpoint according to the common codec type.

3. The media gateway according to claim 1, wherein the interface is further configured to send and receive the encoded voice data to and from the local endpoint within Real-time Transport Protocol (RTP) packets, wherein the processor is further configured to generate the RTP packets including the encoded voice data, wherein the processor is further configured to generate a special in-band RTP packet to be sent to the local endpoint informing of the switch.

4. The media gateway according to claim 1, wherein the interface is further configured to send and receive the encoded voice data to and from the local endpoint within Real-time Transport Protocol (RTP) packets, wherein the processor is further configured to generate the RTP packets including the encoded voice data, wherein the processor is further configured to change a value of a field in an RTP header of the RTP packets to inform the local endpoint of the switch.

5. The media gateway according to claim 1, wherein the interface is further configured to send encoded voice data received from the local endpoint to the remote media gateway via the PCM based TDM trunk encoded according to the common codec type.

6. The media gateway according to claim 1, wherein the interface is further configured to send and receive encoded voice data to and from the local endpoint within Real-time Transport Protocol (RTP) packets, wherein the processor is further configured to generate the RTP packets including the encoded voice data, wherein the processor is further configured to change a payload type value of the RTP packets to indicate the switch to the local endpoint.

7. The media gateway according to claim 1, wherein:
the interface is further configured to:
receive a local endpoint Session Description Protocol (SDP) message specifying the codec types supported by the local endpoint from a local call server associated with the local endpoint; and
to send a media gateway SDP message specifying the codec types supported by the media gateway to the local endpoint; and
the processor is further configured to generate the local TFO message based upon the media gateway SDP message and the local endpoint SDP message.

8. The media gateway according to claim 7, wherein the media gateway SDP message includes an “m=” media field describing a media type and one or more “a=” media attribute fields for describing the one or more codec types.

9. The media gateway according to claim 1, wherein:
the interface is further configured to:
receive a local endpoint Session Initiation Protocol (SIP) message having a Session Description Protocol (SDP) portion including a description of the codec types supported by the local endpoint from a local call manager associated with the local endpoint; and
to send a media gateway SIP message having an SDP portion including a description of codec types supported by the media gateway to the local endpoint; and
the processor is further configured to generate the local TFO message based upon the SDP portions of the local endpoint SIP message and the media gateway SIP message.

10. The media gateway according to claim 9, wherein the local network call server is one of a SIP proxy, H.323 gatekeeper, an MGCP call agent, and a Megaco media gateway controller.

11. The media gateway according to claim 10, wherein the remote media gateway is associated with a remote call manager, wherein the remote call manager is one of a SIP proxy, Media Gateway Control Protocol (MGCP) call agent, Megaco Media Gateway Controller, H.323 gatekeeper and a mobile switching center switch.

12. The media gateway according to claim 1, wherein the interface is further configured to receive the setup messages as one of a Session Initiation Protocol (SIP) message or an H.323 protocol message.

13. A customer premises equipment (CPE) for providing an endpoint-to-endpoint transcoding free connection between the CPE and a remote endpoint, the CPE having a network connection with a packet based communication network, the CPE comprising:
an interface configured to:
send a setup message including a request for a communication link with the remote endpoint and one or more CPE supported codec types for encoding and decoding voice data to a media gateway associated with the packet based communication network;
receive a gateway setup message from the media gateway including one or more gateway supported codec types and an initial codec type to be used for encoding and decoding voice data; and
send and receive Real-time Transport Protocol (RTP) packets including encoded voice data to and from the media gateway; and
a processor coupled to the interface, the processor configured to:
generate the setup message;
determine the initial codec type to be used based upon the gateway setup message, and
encode and decode voice data to be sent to and received from the media gateway according to the initial codec type;
generate the RTP packets including the encoded voice data;
switch from the initial codec type to a common codec type to be used for encoding and decoding the voice data if a payload header of the RTP packets received from the media gateway includes a payload type corresponding to the common codec indicating that the media gateway has switched from the initial codec to the common codec type for providing the transcoding free connection.

14. The CPE according to claim 13, wherein the processor is further configured to generate the setup message as a Session Description Protocol (SDP) message including a “m=” media field describing a media type and one or more “a=” media attribute fields for describing the one or more CPE supported codec types.

15. The CPE according to claim 13, wherein the processor is further configured to generate the setup message as one of a Session Initiation Protocol (SIP) message, a Media Gateway Control Protocol (MCGP) message, a Megaco message and an H.323 protocol message, wherein the packet based communication network is a Voice over Internet Protocol network.

16. A method for providing a transcoding free connection between a first endpoint and a second endpoint, the first endpoint sending and receiving Real-time Transport Protocol (RTP) packets including media data encoded according to a first initial codec to and from a first media gateway via a first communication network, the second endpoint sending and receiving RTP packets including media data encoded according to a second initial codec to and from a second media gateway via a second communication network, the first media gateway decoding the encoded media data received from the first endpoint according to the first initial codec, the second media gateway decoding the encoded media data received from the second endpoint according to the second initial codec, the first media gateway and the second media gateway encoding the media data according to Pulse Code Modulation (PCM) coding, the first media gateway sending and receiving the PCM encoded media data to and from the second media gateway via a link to a Public Switched Telephone Network (PSTN), the method comprising:
performing a Tandem Free Operation (TFO) negotiation based upon a first TFO message received at the second media gateway from the first media gateway and a second TFO message received at the first media gateway from the second media gateway to determine if a common codec type is supported by the first endpoint, the first media gateway, the second media gateway, and the second endpoint, wherein the first TFO message includes a list of one or more codec types supported by the first endpoint and the first media gateway, wherein the second TFO message includes a list of one or more codec types supported by the second endpoint and the second media gateway;
switching from encoding media data at the first media gateway to be sent to the first endpoint from the first initial codec type to the common codec type and sending an indication of the switch to the first endpoint, and switching from encoding media data at the second media gateway to be sent to the second endpoint from the second initial codec type to the common codec type and sending an indication of the switch to the second endpoint;
switching from encoding media data at the first endpoint from the first initial codec type to the common codec type after receiving the indication from the first media gateway and switching from encoding media data at the second endpoint from the second initial codec type to the common codec type after receiving the indication from the second media gateway; and
sending encoded media data received at the first media gateway from the first endpoint to the second media gateway via the PSTN in a transcode free mode in which the media data is encoded according to the common codec type by the first endpoint and sending media data received at the second media gateway from the second endpoint to the first media gateway via the PSTN in the transcode free mode in which the media data is encoded according to the common codec type by the second endpoint.

17. The method of claim 16, wherein the TFO negotiation is performed based upon a TFO protocol.

18. The method of claim 16, wherein the sending of the indication of the switch by the first media gateway and the second media gateway further includes changing a payload type value of the RTP packets.

19. The method of claim 16, wherein one of the first communication network and the second communication network is a Voice over Internet Protocol (VoIP) network.

20. The method of claim 16, wherein the first communication network and the second communication network are Voice over Internet Protocol (VoIP) networks.

21. The method of claim 16, wherein the sending of the indication of the switch by the first media gateway and the second media gateway further includes sending a special RTP packet to the first endpoint and the second endpoint, the special RTP packet specifying the common codec type.

22. A method for providing a Transcoding Free connection between a first endpoint and a second endpoint, the method comprising:
receiving a setup message from the first endpoint, the setup message including a request for a communication link with the second endpoint and one or more first endpoint supported codec types for encoding and decoding media data;
decoding media data received within Real-time Transport Protocol (RTP) packets from the first endpoint according to an initial codec type determined in accordance with the setup message;
encoding the media data according to a Pulse-code Modulation (PCM) coding and sending the encoded PCM media data to a remote media gateway associated with the second endpoint via a PCM based Time Division Multiplexing (TDM) trunk;
performing a first Tandem Free Operation (TFO) negotiation to determine if the initial codec type and a remote codec type associated with the remote media gateway are similar, and stopping the encoding of the media data according to the PCM encoding so that the encoded media data received from the first endpoint is sent via the PCM based TDM trunk to the remote media gateway encoded according to the initial codec type if the initial codec type and the remote codec type are determined to be similar; and
performing a second TFO negotiation if the initial codec type and the remote codec type are determined not to be similar by the first TFO negotiation to determine if a common codec type is supported by the first endpoint, the media gateway, the remote media gateway, and the second endpoint, and switching from encoding media data to be sent to the first endpoint according to the initial codec type to encoding media data to be sent to be sent to the first endpoint according to the common codec type if the common codec type is determined to be supported by the second TFO negotiation and changing a payload type value of in an RTP header of the RTP packets to indicate the switch to the first endpoint.

23. The method according to claim 22, wherein the receiving the setup message from the first endpoint further includes receiving a Session Description Protocol (SDP) message including one or more “m=” media attribute fields for describing the one or more first endpoint supported codec types.

24. The method according to claim 22, wherein the receiving of the setup message from the first endpoint further includes receiving one of a Session Initiation Protocol (SIP) message, a Media Gateway Control Protocol (MGCP) message, a Megaco message, and an H.323 protocol message.

25. The method according to claim 22, further comprising:
receiving encoded media data from the first endpoint encoded according to the common codec type; and
sending the encoded media data according to the common codec type by the first endpoint to the remote media gateway via the PCM based TDM trunk in a Transcoding Free Mode.
